(19) United States
(12) Patent Application Publication
(10) Pub. No.: US 2024/0003640 A1
(43) Pub. Date: Jan. 4, 2024

(54) ARRANGEMENT FOR THE TRANSPORT OF MEDIA

(71) Applicant: TI Automotive Technology Center GmbH, Rastatt (DE)

(72) Inventors: Albert BOECKER, Ettlingen (DE); Matthias WINTER, Karlsruhe (DE); Thorsten SCHAEFER, Steinfeld (DE); Manuel SCHUSTER, Karlsruhe (DE)

(21) Appl. No.: 18/216,122

(22) Filed: Jun. 29, 2023

(30) Foreign Application Priority Data
Jun. 29, 2022 (EP) 22182023.6

(51) Int. Cl. F28F 3/14; B29C 49/20

(52) U.S. Cl. CPC F28F 3/14; B29C 49/20; B29C 2049/2008; B29L 2031/18

(57) ABSTRACT

Arrangement for the transport of media, having at least one base body, wherein the base body forms at least one wall, wherein the wall delimits, at least in sections, two flow channels formed in the base body, wherein the flow channels are separated from one another by at least one separating body arranged in the base body at least in sections.

### RELATED APPLICATIONS

The present disclosure is a national phase application of European Application 22182023.6, filed on Jun. 29, 2021, the entire contents of which is incorporated herein by reference.

### FIELD

The disclosure relates to an arrangement for the transport of media, comprising at least one base body which forms at least one wall which delimits at least two flow channels formed in the base body.

### BACKGROUND

Arrangements for the transport of media are needed, for example, in electromobility. Electric vehicle batteries, especially lithium-ion batteries, show an optimal performance only within a limited temperature spectrum. Depending on the ambient temperature, it may therefore be necessary to heat or cool the batteries. For this purpose, the electric vehicle is equipped with a temperature control circuit that has an arrangement of pipes through which temperature control media, for example temperature control liquid, can be fed to the cells of the battery in order to control their temperature within a desired temperature spectrum. Due to installation space limitations, the temperature control unit should be as compact as possible.

Furthermore, it may be necessary to control the temperature of components of the entire drive unit of electric vehicles and to heat or cool them depending on the operating state. In addition to the batteries, this includes the power electronics and the electric motor, or the electric motors. The temperature of the charging electronics and the associated plug connections and cables can also be controlled by means of the temperature control unit. This is particularly relevant in the context of fast charging processes.

In addition to use in a drive unit, there is a further area of application in connection with other vehicle electronics, here in particular the temperature control of sensors and on-board computers. If a vehicle is equipped for autonomous driving, powerful sensors and powerful computers are required, wherein the systems are redundantly present. Due to the fact that the installation space in a vehicle is limited, these systems also have special requirements for a temperature control unit to control the temperature of these components.

Temperature control media are also used in air conditioning systems. Air conditioning systems, in particular mobile air conditioning systems, comprise a pipe arrangement which enables the transport of temperature control medium between the individual units of the air conditioning system. In mobile air conditioning systems, for example in air conditioning systems used for climate control of the interiors of vehicles, the pipe arrangement is a comparatively complex structure and often comprises pipes made of different materials, for example pipes made of metal, pipe sections made of thermoplastic material and pipe sections made of rubber-like material. Although the operating conditions of the pipe sections can be optimally adapted to the respective requirements, the pipe arrangement is cost-intensive, complex to assemble and difficult to recycle.

From EP 3 919 299 A1, a pipe arrangement for the transport of temperature control medium is known in which a base body forms at least one wall which delimits several flow channels formed in the base body.

### BRIEF SUMMARY

An object of present disclosure is providing an arrangement for the transport of media which, while having a compact design, can have a plurality of flow channels and can be manufactured inexpensively.

This object is solved by the features of the independent claims. The dependent claims refer to advantageous embodiments.

The arrangement for the transport of media according to the present disclosure comprises at least one base body which forms at least one wall which, at least in sections, delimits two flow channels formed in the base body, wherein the flow channels are separated from one another at least in sections by at least one separating body arranged in the base body.

The base body can delimit the flow channels and accordingly form the outer walls of the flow channels in sections. The flow channels are arranged inside the base body and end in passage openings towards the outside. The passage openings can, for example, be shaped as pipe sockets, wherein the pipe sockets are suitable for receiving pipes or hoses. It is also conceivable that units such as pumps, heat exchangers or the like are connected to the passage openings. The flow channels can form pipe sections, wherein the separating body embedded in the base body enables the formation of complex-shaped flow channels. Several flow channels can be arranged in the base body, so that the arrangement can form a pipe junction or manifold.

The separating body enables the design of additional flow channels within the base body, wherein a large number of variations are possible, particularly with regard to the arrangement and orientation of the flow channels. For example, it is conceivable to arrange flow channels both one above the other and next to each other. As a result, the arrangement can be particularly compact and, at the same time, accommodate many flow channels.

The separating body is preferably formed separately from the base body. In doing so, the base body and the separating body form two components which can be materially bonded. The separately formed separating body allows a greater variety of flow channels and their arrangement within the base body. The separating body can be fixed materially bonded in the base body, a frictional connection or a positive connection.

Preferably, the base body is designed as a blow-molded part. Blow molding allows the production of a base body with complex shape. In the process, the base body forms a hollow body with one or more walls that delimit the flow channels arranged inside the base body. Blow molding can produce flow channels with a wide variety of shapes.

Preferably, plastics such as thermoplastic polymers or thermoplastic elastomers are used as the material for the base body. Depending on the pressure conditions in the media transported in the flow channels, the base body can be formed to be single-layered, but also multi-layered. A multi-layered design is particularly advantageous, for example, to counteract diffusion of different components of a fluid mixture. The flow channels can be shaped as required for the mounting location and can, for example, be curved. Furthermore, there is great freedom in the choice of the cross-sectional shape of the flow channels.

Preferably, the separating body is designed as an insert component which is inserted into the blow mold and surrounded by the material of the base body before blow molding in such a way that the separating body is embedded in the base body after blow molding.

The separating body can be formed to be essentially plane. As a result, the separating body has a simple shape and is easy and inexpensive to manufacture. The material can consist of polymeric or metallic material. The materials can be injection moldable or blow moldable.

At least one further flow channel can be formed in the separating body. In this embodiment, the separating body is preferably designed as a hollow body. For this purpose, it is conceivable, for example, that the separating body is designed as a pipe and embedded in the base body. In this embodiment, the circumferential wall of the pipe delimits the further flow channel on the inner circumferential side and, on the outer circumferential side, in each case in sections, also the two flow channels formed from the base body. In this case, however, it is in particular conceivable that the separating body only partially delimits the two flow channels. In doing so, the proportion of the delimitation walls of the two flow channels occupied by the separating body depends on the design of the flow channels and the arrangement of the separating body within the base body.

The separating body can be designed as a blow-molded part. As a result, the separating body can also have a complex shape and, in particular, have several flow channels arranged inside the separating body.

In this context, it is particularly conceivable that the separating body forms at least one wall that separates the further flow channel from the flow channels. It is also conceivable that the base body surrounds the separating body in a shell-shaped manner.

When the arrangement is designed with a base body as a blow-molded part and a separating body as a blow-molded part, a very complex pipe arrangement can be realized. In this case, flow channels can be arranged both in a first plane and in a second plane perpendicular to the first plane (both one below the other and next to each other). Furthermore, it is conceivable that flow channels cross each other and/or run next to each other in one section and one below the other in another section.

In an alternative embodiment, it is conceivable that several separating bodies are provided that are embedded in the base body. According to an advantageous embodiment, separating bodies are at least partially surrounded by other separating bodies. Separating bodies can also be designed as hollow bodies and provided with flow channels on the inside. Accordingly, the arrangement has several separating bodies and/or base bodies nested inside each other, so that a particularly large number of flow channels can be arranged in the arrangement.

Accordingly, several embodiments and arrangements of separating bodies are possible. A first advantageous embodiment provides a single separating body disposed in or associated with the base body.

A second advantageous embodiment provides that several separating bodies are arranged in the base body. In this case, each separating body can delimit a flow channel. For example, it is conceivable to arrange several separating bodies next to each other in the base body. In doing so, each separating body is assigned to a flow channel. Depending on the arrangement of the separating bodies, however, it is also possible for a separating body to delimit a first flow channel on one side and another flow channel on the other side.

According to a third embodiment, several, at least two, separating bodies are provided, wherein the separating bodies are nested within each other. In this embodiment, it is conceivable, for example, that the arrangement forms a heat exchanger.

According to a fourth embodiment, several separating bodies are arranged in the base body, wherein first separating bodies are arranged next to each other, and second separating bodies are arranged nested within each other. This embodiment allows a particularly complex configuration of an arrangement to be produced inexpensively and simply.

At least one functional element influencing at least one flow channel can be arranged in the base body. The functional element can either directly influence the volume flow of the medium guided in the flow channel or record condition data of the medium such as temperature, volume flow or pressure. In doing so, the functional element can influence the medium in one flow channel, several flow channels or all flow channels arranged in the arrangement. It is also conceivable that the functional element is formed as a cooler or as a heating element.

The functional element may be formed from the base body. This is particularly conceivable if the functional element is a passive functional element and has no moving parts. For example, the functional element may form a throttle valve.

The medium conveyed in the flow channels is preferably a temperature control medium, wherein liquid water-based temperature control media, for example water-glycol mixtures, are particularly suitable. In alternative embodiments, the medium is an oil-based liquid or a dielectric liquid that is transported in the flow channels.

The functional element may be a valve, wherein the functional element has openings that are in contact with the flow channels. The valve can affect one or more flow channels, open or close the one or more flow channels, or modify the cross-section of the one or more flow channels to change the volume flow.

According to an advantageous embodiment, the valve is a rotary valve. Rotary valves are often used in temperature control circuits to control the temperature control medium. The rotary valve comprises a valve housing having a valve chamber, wherein the valve chamber has a circumferential wall in which at least two fluid openings are provided, wherein the valve chamber accommodates a valve core, wherein the valve core is provided with a channel structure which cooperates with the fluid openings. The valve core is pivoted in the valve chamber. Such a rotary valve is known, for example, from EP 4 008 935 A1.

In the present embodiment, it is particularly conceivable that the valve housing is formed in one piece from the base body and is made of the same material. Alternatively, it is conceivable that the valve housing of the rotary valve is made up of several parts and the base body forms the outer component of the valve housing. Preferably, the rotary valve is at least partially embedded in the base body. In the case of a rotary valve, it is advantageous that the temperature control medium flow is adjusted by rotating the valve core, wherein the actuator for rotating the valve can be designed in a simple manner and be controllable.

In the arrangement according to the disclosure, it is conceivable that at least two flow channels end in openings of the rotary valve which are arranged in a plane perpendicular to the longitudinal axis. In most cases, the openings of a rotary valve are arranged one above the other when viewed in the longitudinal direction, which limits the possibilities for fluid control. In the embodiment according to the disclosure, it is conceivable that openings are provided in the rotary valve which are also located in a plane perpendicular to the longitudinal axis. This increases the possibilities for controlling the volume flows in the direction of the flow channels. Furthermore, it is conceivable to make the arrangement particularly compact with rotary valves.

The separating body can form a heat transmitter. A particularly effective heat transmitter results in particular when the separating body is made of metallic material. To improve transmission performance, the separating body can be provided with texturing on the surfaces facing the flow channels. In this respect, the separating body can be designed as a heat exchanger insert made of metallic material. The heat transfer medium can be a water-based temperature control medium such as a water-glycol mixture, an oil-based liquid, or a dielectric liquid. The separating body may have openings that communicate with the flow channels.

In the method according to the present disclosure for producing an arrangement for transporting media, in a first step, at least one separating body is placed in a blow mold and then a preform made of polymeric material is arranged in the blow mold in such a way that the preform at least partially surrounds the separating body, in a next step, the arrangement is formed by means of blow molding, wherein the preform forms the base body which forms at least one wall and delimits at least two flow channels formed in the base body, wherein the flow channels are separated from each other by the separating body arranged in the base body.

According to a further method according to the present disclosure, a preform made of polymeric material is arranged in a blow mold, in a next step, the arrangement is formed by means of blow molding, wherein the preform forms the base body which forms at least one wall, subsequently, the blow mold is opened and the base body and two base body parts are separated, in a next step, at least one separating body is inserted into the blow mold, the blow mold is closed again and the two base body parts are materially bonded and connected in a fluid-tight manner, wherein the base body at least partially surrounds the separating body and delimits at least two flow channels formed in the base body, wherein the flow channels are separated from one another by the separating body arranged in the base body.

### BRIEF DESCRIPTION OF THE DRAWINGS

Some embodiments of the arrangement for transporting media according to the present disclosure are explained in more detail below with reference to the figures. These show, each schematically:

FIG. 1 a first embodiment of an arrangement in section;

FIG. 2 a second embodiment of an arrangement in section;

FIG. 3 the arrangement according to FIG. 1 in cross-section.

### DETAILED DESCRIPTION

The figures show an arrangement 1 for transporting media. In the present embodiments, the arrangement 1 serves to transport temperature control media in the form of a cooling liquid. The arrangement 1 is part of the temperature control unit of an electric vehicle. Accordingly, temperature control medium in form of cooling liquid flows through the flow channels 4, 5, 7 formed in the arrangement 1 to the batteries, the power electronics, the charging electronics and the electric motors.

The arrangement 1 comprises a base body 2 in form of a hollow body which forms a wall 3 delimiting flow channels 4, 5. A separating body 6 is embedded in the base body 2 to separate the two flow channels 4, 5 from each other.

The base body 2 is designed as a blow-molded part and is made of polymeric material.

To produce the arrangement 1, a separating body 6 is placed in a blow mold, then a preform which at least partially accommodates the separating body 6 is placed in the blow mold. In the present embodiment, the preform is formed as a tube which is slipped over the separating body 6. Depending on the design of the arrangement 1, functional elements 9, for example valves, pumps, sensors and the like, can then be arranged in the blow mold. The blow mold is then closed and the base body 2 is formed from the preform in the blow molding process. Due to the fact that the preform is slipped over the separating body 6, the separating body 6 is embedded in the base body 2 after blow molding. As a result of the blow molding, flow channels 4, 5, 7 are formed inside the base body 2, wherein the flow channels 4, 5, 7 are delimited from one another by the wall 3 of the base body 2 and the separating body 6.

According to an alternative method, a preform is first placed in the blow mold which comprises two mold halves provided with a cavity, wherein the preform preferably is formed as a tube, the blow mold is then closed by moving the two mold halves towards each other, and the base body 2 is first formed by means of blow molding. In a next step, the blow mold is opened, wherein the base body 2 is fixed in the blow mold in such a way that the base body 2 tears into two base body parts along the seam created between the two mold halves. The separating body 6 or several separating bodies 6 and, if necessary, one or more functional elements 9 are inserted between the two base body parts and the blow mold is closed again, wherein the two base body parts join again becoming materially bonded to form the base body 2. Preferably, the joining of the two base body parts takes place shortly after the shaping of the base body 2, so that the temperature of the base body parts is sufficient for a material bond.

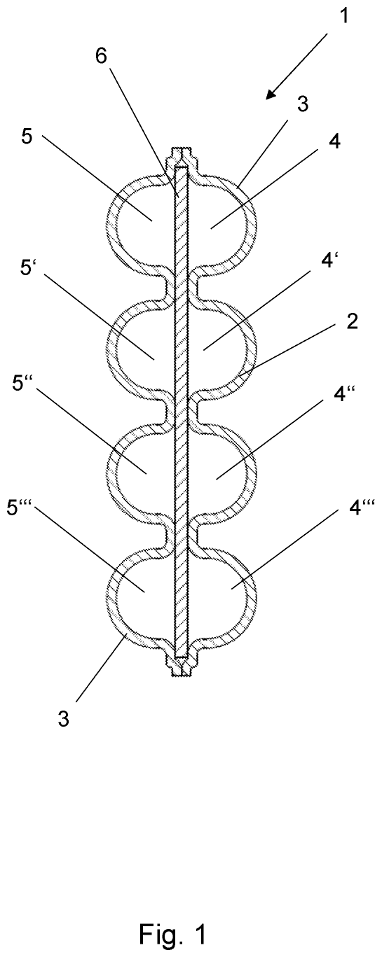

FIG. 1 shows a first embodiment of the arrangement 1 in which the separating body 6 is plane. In the present embodiment, the separating body 6 is made of metallic material. In the present embodiment, the separating body 6 forms a heat transmitter. To improve heat transfer, the surfaces facing the flow channels 4, 5 are textured. According to an advantageous embodiment, the separating body 6 is formed from injection-moldable plastic.

The arrangement according to FIG. 1 has eight flow channels 4, 4′, 4″, 4′″, 5, 5′, 5″, 5′″, wherein the flow channels 4, 4′, 4″, 4′″ as well as the flow channels 5, 5′, 5″, 5″ are each arranged one above the other and the flow channels 4, 4′, 4″, 4′″ are each adjacent to the flow channels 5, 5′, 5″, 5″. Next to each other adjacent flow channels 4, 4′, 4″, 4′″, 5, 5′, 5″, 5′″ are separated from each other by the separating body 6, respectively, and the flow channels 4, 4′, 4″, 4′″, 5, 5′, 5″, 5′″ arranged one above the other are each delimited by the wall 3 formed from the base body 2.

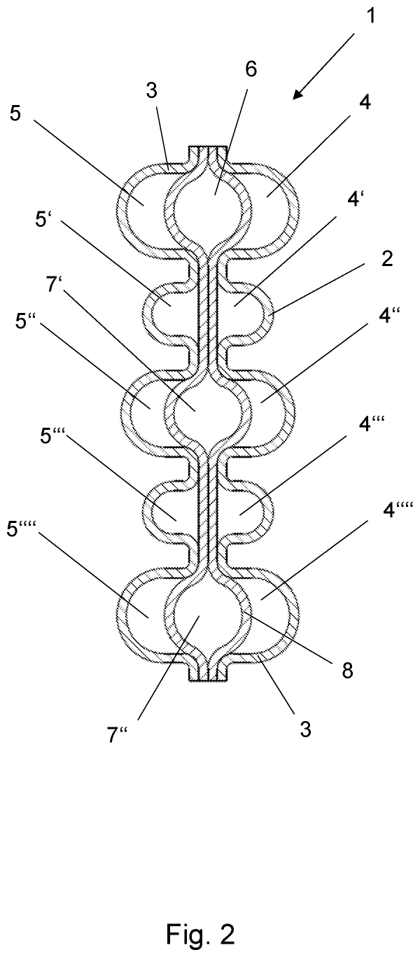

In the embodiment according to FIG. 2, the separating body 6 is also a blow-molded part and forms a hollow body. The separating body 6 is made of polymeric material by blow molding. Further flow channels 7, 7′, 7″ are formed in the separating body 6.

The separating body 6 forms a further wall 8 separating the further flow channels 7, 7′, 7″ from the flow channels 4, 4′, 4″, 4′″, 5, 5′, 5″, 5′″. The base body 2 surrounds the separating body 6 in a shell-shaped manner. Accordingly, the arrangement has 13 flow channels, wherein flow channels are embedded one above the other and next to each other in the base body 2.

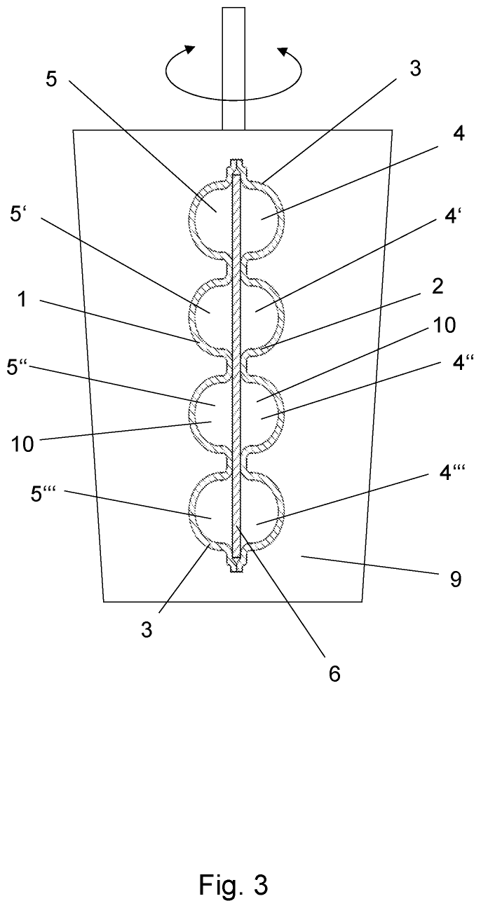

FIG. 3 shows an arrangement 1 according to FIG. 1 in cross-section, wherein the sectional plane extends through the base body 2. In this embodiment, a functional element 9 influencing the flow channels 4, 4′, 4″, 4′″, 4″″, 5, 5′, 5″, 5″, 5″″ is arranged in the base body 2. The flow channels designated 5, 5′, 5″, 5″, 5″″ are located in mirror image to the flow channels 4, 4′, 4″, 4′″, 4″″, wherein all flow channels end in the functional element 9. In the present embodiment, the functional element 9 is a valve, wherein the functional element 9 has openings 10 that are in contact with the flow channels 4, 4′, 4″, 4′″, 4″″, 5, 5′, 5″, 5′″, 5″″. Specifically, the valve is a rotary valve.

In this case, the flow channels 4, 4′, 4″, 4′″ 4″″, 5, 5′, 5″, 5′″, 5″″ end in openings 10 of the rotary valve, wherein two openings 10 are arranged in a plane perpendicular to the longitudinal axis in each case. As a result, the flow channels 4, 4′, 4″, 4′″,4″″ and 5, 5′, 5″, 5′″, 5″″ respectively end one above the other, and the flow channels 4, 5 and 4′, 5′ and 4″, 5″ and 4′″, 5′″ and 4″″, 5″″ respectively open next to each other in a plane perpendicular to the longitudinal axis of the valve core pivoted in the rotary valve.

Embedded in the base body 2, is a further functional element (not shown) in the form of a check valve which influences a flow channel.

1. Arrangement for the transport of media, comprising at least one base body, wherein the base body forms at least one wall, wherein the wall delimits, at least in sections, two flow channels formed in the base body, characterized in that the flow channels are separated from one another by at least one separating body arranged in the base body at least in sections.

2. Arrangement according to claim 1, wherein the separating body is formed separately from the base body.

3. Arrangement according to claim 1, wherein the base body is formed as a blow-molded part.

4. Arrangement according to claim 1, wherein the separating body is formed substantially plane.

5. A arrangement according to claim 1, wherein the separating body consists of injection-moldable or metallic material.

6. Arrangement according to claim 1, wherein at least one further flow channel is formed in the separating body.

7. Arrangement according to claim 1, wherein the separating body is formed as a blow-molded part.

8. Arrangement according to claim 6, wherein the separating body forms at least one further wall that separates the further flow channel from the flow channels.

9. Arrangement according to claim 1, wherein the base body surrounds the separating body in a shell-shaped manner.

10. Arrangement according to claim 1, wherein at least one functional element is arranged in the base body, wherein the functional element can be brought into contact with a medium guided in the flow channels.

11. Arrangement according to claim 10, wherein the functional element is a valve, wherein the functional element has openings that are in contact with the flow channels.

12. Arrangement according to claim 11, wherein the valve is a rotary valve.

13. Arrangement according to claim 12, wherein at least two flow channels end in openings of the rotary valve which are arranged in a plane perpendicular to the longitudinal axis of the rotary valve.

14. Arrangement according to claim 1, wherein the separating body forms a heat transmitter.

15. Method for producing an arrangement for the transport of media according to claim 1, in a first step, at least one separating body is placed in a blow mold and, subsequently, a preform made of polymeric material is arranged in the blow mold in such a way that the preform at least partially surrounds the separating body, in a next step, the arrangement is formed by means of a blow molding method, wherein the preform forms the base body which forms at least one wall and delimits at least two flow channels formed in the base body, wherein the flow channels are separated from one another by the separating body arranged in the base body.

16. Method for producing an arrangement for the transport of media according to claim 1, in a first step, a preform made of polymeric material is arranged in a blow mold, in a next step, the arrangement is formed by means of a blow molding method, wherein the preform forms the base body which forms at least one wall, then, the blow mold is opened and the base body and two base body parts are separated, in a next step, at least one separating body is inserted into the blow mold, the blow mold is closed again and the two base body parts are joined materially bonded, wherein the base body at least partially surrounds the separating body and delimits at least two flow channels formed in the base body, wherein the flow channels are separated from one another by the separating body arranged in the base body.
